(19) United States
(12) Patent Application Publication
(10) Pub. No.: US 2012/0120351 A1
(43) Pub. Date: May 17, 2012

(54) LIQUID CRYSTAL DISPLAY DEVICE

(76) Inventor: Yasushi KAWATA, Ageo-shi (JP)

(21) Appl. No.: 13/276,442

(22) Filed: Oct. 19, 2011

(30) Foreign Application Priority Data
Nov. 17, 2010 (JP) 2010-256988

(51) Int. Cl. G02F 1/1335; G02F 1/137

(52) U.S. Cl. 349/105

(57) ABSTRACT

According to one embodiment, a liquid crystal display device of a guest-host type includes an array substrate including a switching element and a reflective electrode connected to the switching element, a counter-substrate including a counter-electrode which is opposed to the reflective electrode, and a liquid crystal layer held between the array substrate and the counter-substrate, and including liquid crystal molecules and dichroic dyes. The liquid crystal layer has a blue phase.

### CROSS-REFERENCE TO RELATED APPLICATIONS

This application is based upon and claims the benefit of priority from prior Japanese Patent Application No. 2010-256988, filed Nov. 17, 2010, the entire contents of which are incorporated herein by reference.

### FIELD

Embodiments described herein relate generally to a liquid crystal display device.

### BACKGROUND

By virtue of such features as light weight, small thickness and low power consumption, liquid crystal display devices have been used in various fields as display devices of OA equipment such as personal computers, information terminals, timepieces, TVs, etc. In particular, by virtue of high responsivity, liquid crystal display devices using thin-film transistors are widely used as monitors of mobile terminals, computers, etc., which display a great deal of information.

In recent years, liquid crystal display devices have also been used as display devices of portable information terminal devices such as a mobile phone and a personal digital assistant (PDA). In such liquid crystal display devices used in various fields, there has been an increasing demand for a smaller thickness and a lighter weight, as well as capabilities, from the standpoint of design and portability.

In particular, recently, there has been an increasing demand for lower power consumption in consideration of environment, and an improvement in characteristics of a reflective liquid crystal display device, which requires no backlight, is desired. For example, there has been proposed a reflective guest-host type liquid crystal display device, for example.

### BRIEF DESCRIPTION OF THE DRAWINGS

FIG. 1 is a view which schematically shows a structure of a liquid crystal display device according to an embodiment.

FIG. 2 is a view which schematically shows a voltage non-application state in which no potential difference is produced between a reflective electrode and a counter-electrode in the liquid crystal display device shown in FIG. 1.

FIG. 3 is a view which schematically shows a voltage application state in which a potential difference is produced between the reflective electrode and the counter-electrode in the liquid crystal display device shown in FIG. 1.

FIG. 4 is a view which schematically shows another structure of the liquid crystal display device according to the embodiment.

### DETAILED DESCRIPTION

In general, according to one embodiment, a liquid crystal display device of a guest-host type includes an array substrate including a switching element and a reflective electrode connected to the switching element; a counter-substrate including a counter-electrode which is opposed to the reflective electrode; and a liquid crystal layer held between the array substrate and the counter-substrate, and including liquid crystal molecules and dichroic dyes. The liquid crystal layer has a blue phase.

Embodiments will now be described in detail with reference to the accompanying drawings. In the drawings, structural elements having identical or similar functions are denoted by like reference numerals, and an overlapping description is omitted.

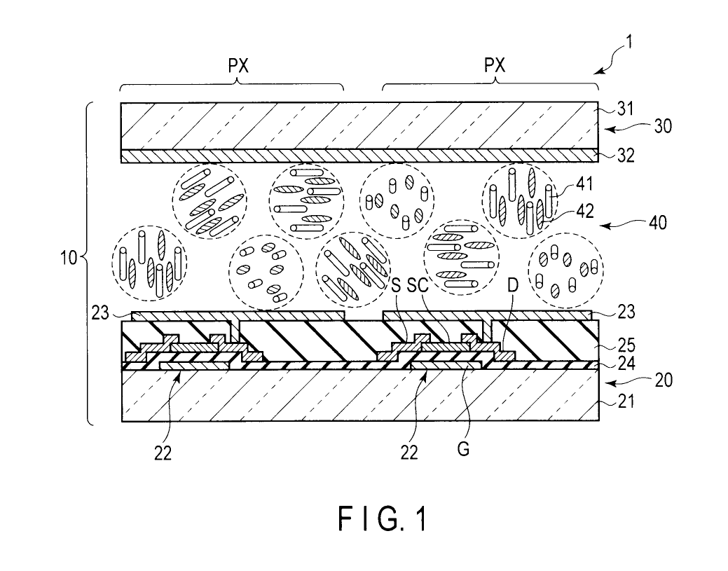

FIG. 1 is a view which schematically shows a structure of a liquid crystal display device 1 according to an embodiment.

The liquid crystal display device 1 in this embodiment is a guest-host type liquid crystal display device, and includes a liquid crystal display panel 10. The liquid crystal display panel 10 includes an array substrate 20, a counter-substrate 30, and a liquid crystal layer 40 which is held between the array substrate 20 and counter-substrate 30. A predetermined gap for holding the liquid crystal layer 40 is created between the array substrate 20 and the counter-substrate 30. The array substrate 20 and counter-substrate 30 are attached by a sealant.

The array substrate 20 is formed by using a first insulative substrate 21 such as a glass substrate or a plastic substrate. The array substrate 20 includes switching elements 22 and reflective electrodes 23, which are connected to the switching elements 22, which are provided on the first insulative substrate 21. A description below is given of the case in which the switching element 22 is a bottom-gate-type thin-film transistor including an amorphous silicon semiconductor layer. The switching element 22 is not limited to the example illustrated, but may be a thin-film transistor including a polycrystalline silicon semiconductor layer, or a thin-film transistor having a top-gate-type structure. In the example illustrated, the switching elements 22 are disposed in two neighboring pixels, respectively.

A gate electrode G of the switching element 22 is formed on the first insulative substrate 21. The gate electrode G is electrically connected to a scanning line, or is formed integral with the scanning line. The gate electrode G is covered with a gate insulation film 24. A semiconductor layer SC of the switching element 22 is formed on the gate insulation film 24, and is positioned immediately above the gate electrode G. The semiconductor layer SC is formed of amorphous silicon of an island shape.

A source electrode S and a drain electrode D of the switching element 22 are formed on the gate insulation film 24 and are put in contact with the semiconductor layer SC. The source electrode S is electrically connected to a signal line, or is formed integral with the signal line. The source electrode S and drain electrode D are covered with an interlayer insulation film 25.

The reflective electrode 23 is a pixel electrode and is disposed in each pixel. In the example illustrated, the reflective electrode 23 is disposed in each of two pixels. The reflective electrode 23 is formed on the interlayer insulation film 25. The reflective electrode 23 is formed of an electrically conductive material with light reflectivity, such as aluminum (Al) or silver (Ag). The reflective electrode 23 is electrically connected to the drain electrode D of the switching element 22 of each pixel.

The counter-substrate 30 is formed by using a second insulative substrate 31 such as a glass substrate or a plastic substrate. The counter-substrate 30 includes a counter-electrode 32 on the second insulative substrate 31, that is, on that surface of the second insulative substrate 31, which is opposed to the reflective electrodes 23.

The counter-electrode 32 is a common electrode and is disposed over a plurality of pixels. In the example illustrated, the counter-electrode 32 is disposed commonly to two pixels, and is opposed to the reflective electrodes 23 of the respective pixels. The counter-electrode 32 is formed of an electrically conductive material with light transmissivity, such as indium tin oxide (ITO) or indium zinc oxide (IZO). The counter-electrode 32 is formed over the entire surface at positions opposed to the reflective electrodes 23, and the counter-electrode 32 includes no slit or opening. A common potential is applied to the counter-electrode 32.

Spacers for creating a predetermined cell gap are disposed between the array substrate 20 and counter-substrate 30. The liquid crystal layer 40 is formed of a liquid crystal material which is sealed in the cell gap between the array substrate 20 and counter-substrate 30.

In the example shown in FIG. 1, a thin film, such as an alignment film, which has a liquid crystal alignment restricting force, is not present on the surface of each reflective electrode 23, and the reflective electrodes 23 and the liquid crystal layer 40 are in contact. In addition, a thin film, such as an alignment film, which has a liquid crystal alignment restricting force, is not present on the surface of the counter-electrode 32, and the counter-electrode 32 and liquid crystal layer 40 are in contact. In the case where the reflective electrodes 23 and counter-electrode 32 are formed of an electrically conductive material having corrosion resistance to the liquid crystal material, there arises no problem even if the reflective electrodes 23 and counter-electrode 32 are in contact with the liquid crystal layer 40. In addition, the number of components can be reduced and the manufacturing process can be simplified, and therefore the manufacturing cost can be reduced.

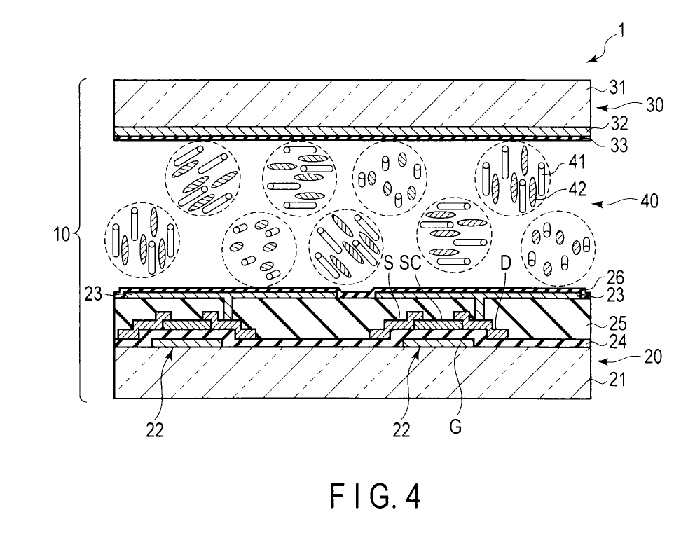

In an example illustrated in FIG. 4, compared to the example of FIG. 1, the reflective electrodes 23 are coated with a first passivation film 26, and the counter-electrode 32 is coated with a second passivation film 33. The first passivation film 26 is disposed between the reflective electrodes 23, on the one hand, and the liquid crystal layer 40, on the other hand. The second passivation film 33 is disposed between the counter-electrode 32 and the liquid crystal layer 40. The first passivation film 26 and second passivation film 33 are thin films having no liquid crystal alignment restricting force. In short, each of the first passivation film 26 and second passivation film 33 is different from an alignment film which requires alignment treatment such as rubbing. In the case of this structure, corrosion of the reflective electrodes 23 and corrosion of the counter-electrode 32 can be suppressed, thus contributing to enhancing the reliability. In addition, compared to the case of forming an alignment film, no alignment treatment is needed and the manufacturing process can be simplified.

In the present embodiment, the liquid crystal layer 40 includes not only liquid crystal molecules 41 of the liquid crystal material, but also dichroic dyes 40. The liquid crystal layer 40 has a blue phase. The liquid crystal material, which constitutes the liquid crystal layer 40, is a liquid crystal material (Np type liquid crystal) with a positive dielectric constant anisotropy. The dichroic dye 42 is a compound of a rod-like structure, and has such characteristics that the optical axis (major axis) of the dichroic dye 42 is aligned in parallel to the major axis of the liquid crystal molecule 41.

An optical element, such as a polarizer or a retardation plate, is not disposed on the outer surface of the array substrate 20, i.e. that surface of the first insulative substrate 21, which is opposed to the surface thereof on which the switching element 22 is formed, or on the outer surface of the counter-substrate 30, i.e. that surface of the second insulative substrate 31, which is opposed to the surface thereof on which the counter-electrode 32 is formed.

In a reflective liquid crystal display device of a conventional system, which requires a polarizer, there is a problem that the visibility lowers due to a decrease in reflection luminance. By contrast, in the reflective liquid crystal display device of the guest-host system, which requires no polarizer, this problem can be solved. Moreover, in achieving the improvement of the contrast ratio and the improvement of reflection luminance, it is possible to adopt multilayer implementation, a super-twisted mode, and a polymer dispersed liquid crystal (PDLC).

A brief description is given of the system in which a simple body of blue-phase liquid crystal material (i.e. a liquid crystal layer including no dichroic dye) is used as the liquid crystal layer 40. In this system, polarization conversion needs to be performed by optical anisotropy which is induced by an electric field that is applied to the liquid crystal layer, and, in usual cases, this system can be realized by only a transverse electric field method. The transverse electric field method is a method in which a voltage is applied between a pixel electrode and a common electrode, which are provided in juxtaposition in a planar shape on the side of one of the substrates.

The blue phase is a pseudo-isotropic phase which does not macroscopically exhibit optical anisotropy at a voltage non-application time when no voltage is applied between the pixel electrode and the common electrode. Specifically, since the blue phase is a random state in which liquid crystal molecules are aligned in random directions, linearly polarized light, which is incident on the blue-phase liquid crystal layer from the outside, does not undergo optical modulation. While keeping the polarization state at the time of incidence, the light is absorbed by the polarizer which is disposed on the counter-substrate side, and a dark state occurs. On the other hand, at a voltage application time when a voltage is applied between the pixel electrode and the common electrode, the liquid crystal molecules are aligned in a direction which is substantially parallel to the electric field in the liquid crystal layer, and function as a λ/2 phase conversion element (λ is a wavelength of incident linearly polarized light). Thus, the linearly polarized light, which is incident on the liquid crystal layer, passes through the polarizer which is disposed on the counter-substrate side, in the state in which the linearly polarized light undergoes a 90° phase shift, and a light state occurs.

In this transverse electric field system, in order to obtain a high contrast ratio or a high transmittance, it is required to increase the intensity of electric field. However, in order to increase the intensity of electric field, it is necessary to narrow the distance between electrodes. Consequently, the aperture ratio decreases, and there arises a problem of such a trade-off.

Taking the above into account, in the present embodiment, the reflective liquid crystal display device, which adopts a vertical electric field method, is provided by using the liquid crystal layer 40 which, although having the blue phase, includes the dichroic dyes 42. The operational principle of the liquid crystal display device 1 in this embodiment is described below.

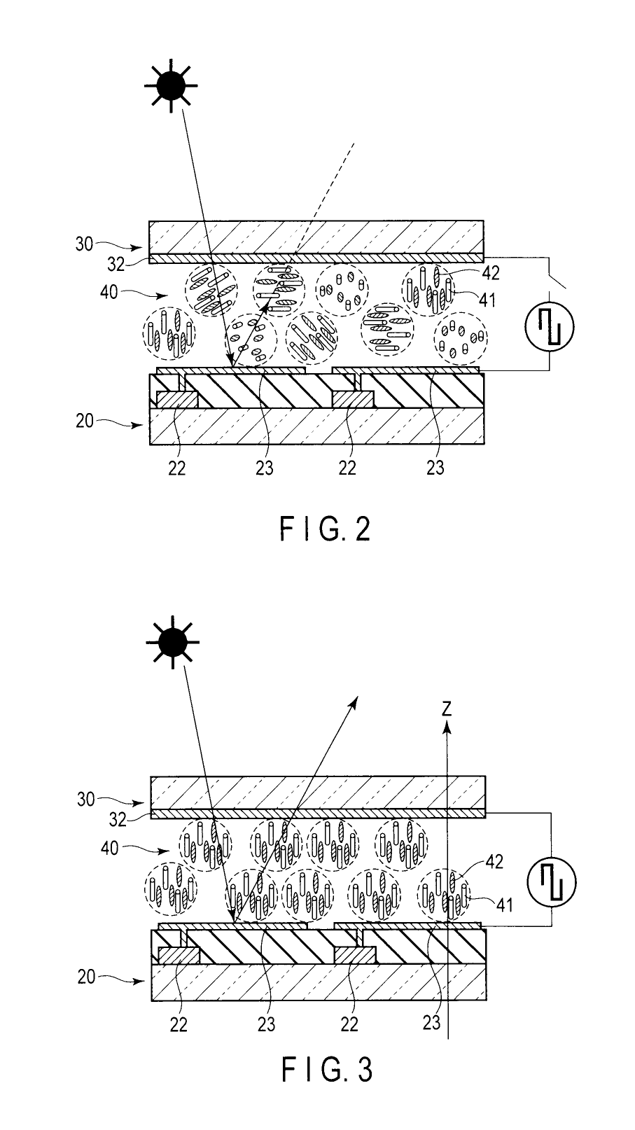

FIG. 2 is a view which schematically shows a voltage non-application state (OFF state) in which no potential difference is produced between the reflective electrode 23 and the counter-electrode 32 in the liquid crystal display device 1 shown in FIG. 1. The liquid crystal layer 40 having the blue phase has, in the voltage non-application state, a pseudo-isotropic phase which does not macroscopically exhibit optical anisotropy. Specifically, the major axes of the liquid crystal molecules 41 are aligned in random directions. At this time, the directions of optical axes of the dichroic dyes 42 mixed in the liquid crystal layer 40 are in such an alignment state that regular optical anisotropy is not macroscopically exhibited in accordance with the alignment of the liquid crystal modules 41 (i.e. in a random state). Hence, incident light, which is incident on the blue-phase liquid crystal layer 40 from the outside, is absorbed by the dichroic dyes 42 in the liquid crystal layer 40 and is colored.

FIG. 3 is a view which schematically shows a voltage application state (ON state) in which a potential difference is produced between the reflective electrode 23 and the counter-electrode 32 in the liquid crystal display device 1 shown in FIG. 1.

In the voltage application state, the liquid crystal layer 40 having the blue phase exhibits anisotropy, since the liquid crystal molecules 41 are aligned in a direction which is substantially parallel to the electric field in the liquid crystal layer 40. Specifically, the major axes of the liquid crystal molecules 41 having a positive dielectric constant anisotropy are aligned in a direction which is substantially parallel to the vertical electric field produced between the reflective electrode 23 and counter-electrode 32 (i.e. the electric field produced along the normal of the substrate). At this time, the directions of optical axes of the dichroic dyes 42 mixed in the liquid crystal layer 40 are substantially parallel to the electric field in the liquid crystal layer 40 in accordance with the alignment of the liquid crystal molecules 41. In short, both the liquid crystal molecules 41 and dichroic dyes 42 are aligned in a direction parallel to a normal Z of the substrate. Accordingly, incident light, which is incident on the blue-phase liquid crystal layer 40 from the outside, is hardly absorbed by the dichroic dyes 42 in the liquid crystal layer 40, and becomes colorless.

As has been described above, in the present embodiment, in the guest-host type reflective liquid crystal display device, the material having the blue phase is used as the constituent material of the liquid crystal layer 40 which exhibits a response to an electric field, and the liquid crystal layer 40 includes the dichroic dyes 42. Thereby, display can be effected in the light absorption state (color state) of the dichroic dyes 42 which are randomly aligned in the voltage non-application state, and in the non-light-absorption state (colorless state) of the dichroic dyes 42 which are vertically aligned in the voltage application state in which a voltage is applied between the reflective electrode 23 and counter-electrode 32.

In particular, in the voltage non-application state in the liquid crystal layer 40, the dichroic dyes 42 are set in the random alignment state. Thereby, the light absorption efficiency can easily be improved without adopting such a method as multilayer implementation, a super-twisted mode or a polymer dispersed liquid crystal (PDLC). Therefore, the contrast ratio and the reflection luminance can be improved. Furthermore, an improvement in absorption efficiency of non-polarized light can be expected from the random alignment state of the dye material of the dichroic dyes 42. In this respect, too, the effect of using the liquid crystal layer 40 having the blue phase is great.

Since the contrast ratio and the reflection luminance can be improved, as described above, a good display quality can be obtained.

In addition, in the present embodiment, since the vertical electric field method can be adopted, it is possible to suppress the decrease in aperture ratio and the increase in driving voltage, which are the problems of the transverse electric field method. Besides, since the counter-electrode 32, which is provided on the counter-substrate 30, is formed over the entire surface at positions opposed to the reflective electrodes 23, it is possible to prevent an undesired electric field from coming into the liquid crystal layer from the outside. Therefore, a disturbance of the alignment in the liquid crystal layer, in particular, in the ON state, can be suppressed.

Furthermore, since the liquid crystal layer 40 having the blue phase does not require regular alignment of liquid crystal molecules 41 in the state in which no voltage is applied, the liquid crystal layer 40 does not require a polymer thin film such as an alignment film, which has a liquid crystal alignment restricting force. In the interface state of the polymer alignment film which restricts the alignment of liquid crystal molecules, a display defect, such as dye coagulation, tends to easily occur due to an interaction between the dichroic dye 42 mixed in the liquid crystal layer 40 and the alignment film interface. Thus, in the mode which requires no alignment film as in the present embodiment, it is possible to selectively create the interface state which decreases the interaction with the dichroic dye 42, and the display reliability can be enhanced.

### EXAMPLE

A guest-host liquid crystal layer 40, in which a liquid crystal material having a blue phase and 3 wt % of a dichroic dye were mixed, was filled in a cell gap (space) formed between an array substrate 20 and a counter-substrate 30. Thereby, a reflective liquid crystal display panel 10 was formed. In a voltage non-application state, light, which was incident on the liquid crystal display panel 10 from the outside, was absorbed by the dichroic dye 42 in the blue phase, and a color display state occurred.

On the other hand, in a voltage application state, no light absorption occurred in the dichroic dye 42 which had regularity due to anisotropy induced by an external electric field. The incident light was hardly colored in the liquid crystal layer 40, and was confirmed as reflective light as such.

As has been described above, according to the present embodiment, there can be provided a liquid crystal display device which has a good display quality and can suppress an increase in driving voltage.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display device of a guest-host type, comprising:
an array substrate comprising a switching element and a reflective electrode connected to the switching element;
a counter-substrate comprising a counter-electrode which is opposed to the reflective electrode; and
a liquid crystal layer held between the array substrate and the counter-substrate, comprising liquid crystal molecules and dichroic dyes, and the liquid crystal layer having a blue phase.

2. The liquid crystal display device according to claim 1, wherein the blue phase is a pseudo-isotropic phase.

3. The liquid crystal display device according to claim 1, wherein directions of optical axes of the dichroic dyes comprised in the liquid crystal layer are controlled by a potential difference between the reflective electrode and the counter-electrode,
the directions of the optical axes of the dichroic dyes in a voltage non-application state are in a random state which exhibits no regular optical anisotropy, and
the directions of the optical axes of the dichroic dyes in a voltage application state are substantially parallel to an electric field in the liquid crystal layer.

4. The liquid crystal display device according to claim 1, wherein a liquid crystal material, which constitutes the liquid crystal layer, is a liquid crystal material with a positive dielectric constant anisotropy.

5. The liquid crystal display device according to claim 1, wherein at least one of the reflective electrode and the counter-electrode is in contact with the liquid crystal layer.

6. The liquid crystal display device according to claim 1, wherein at least one of the reflective electrode and the counter-electrode is coated with a passivation film having no liquid crystal alignment restricting force.

7. The liquid crystal display device according to claim 1, wherein the dichroic dyes are compounds of rod-like structures, and optical axes of the dichroic dyes are aligned in parallel to major axes of the liquid crystal molecules.

8. The liquid crystal display device according to claim 1, wherein no polarizer is disposed on an outer surface of the counter-substrate.

9. The liquid crystal display device according to claim 1, wherein the counter-electrode is formed over an entire surface at a position opposed to the reflective electrode.
